(19) United States
(12) Patent Application Publication
(10) Pub. No.: US 2023/0204388 A1
(43) Pub. Date: Jun. 29, 2023

(54) SENSOR/ACTUATOR UNIT

(71) Applicant: Fraunhofer-Gesellschaft zur Förderung der angewandten Forschung e.V., München (DE)

(72) Inventors: Hendrik RENTZSCH, Chemnitz (DE); Johann HEYSZL, Garching bei München (DE); Stefan HRISTOZOV, Garching bei München (DE); Robin KURTH, Chemnitz (DE); Frank BURKHARDT, Erlangen (DE)

(21) Appl. No.: 18/176,543

(22) Filed: Mar. 1, 2023

Related U.S. Application Data
(63) Continuation of application No. PCT/EP2021/074388, filed on Sep. 3, 2021.

(30) Foreign Application Priority Data
Sep. 4, 2020 (DE) 10 2020 211 180.4

(51) Int. Cl. G01D 3/028; G01L 5/00; B23Q 1/25

(52) U.S. Cl. CPC G01D 3/028; G01L 5/0028; B23Q 1/25

(57) ABSTRACT

Embodiments provide a sensor/actuator unit for mechanical equipment, in particular a tool machine or generally for applications with (high) dynamic load, such as impact load. The sensor/actuator unit comprises a sensor element and/or actuator element as well as a vibrating element. The sensor element is configured to measure a physical measured quantity, such as an acceleration, acting on the environment of the sensor/actuator unit or the sensor element. The actuator element is configured to effect a regulated quantity. Sensor and actuator elements can also be combined. The vibrating element, such as an oscillator is provided with a readjustment. The readjustment is configured to readjust the vibrating element in dependence on a movement of the sensor/actuator unit.

### CROSS-REFERENCE TO RELATED APPLICATIONS

This application is a continuation of copending International Application No. PCT/EP2021/074388, filed Sep. 3, 2021, which is incorporated herein by reference in its entirety, and additionally claims priority from German Application No. 10 2020 211 180.4, filed Sep. 4, 2020, which is also incorporated herein by reference in its entirety.

Embodiments of the present invention relate to a sensor/actuator unit for mechanical equipment, in particular, a tool machine such as a sheet metal press. Further embodiments relate to a method for operating the sensor/actuator unit as well as a respective computer program.

### BACKGROUND OF THE INVENTION

Sheet metal presses or other large mechanical equipment, such as manufacturing robots, typically includes a network of sensor technology or actuator technology distributed across the equipment. Sensors, such as pressure sensors or temperature sensors can be electrically included in the equipment control, for example. Here, cable harnesses are routed along the equipment.

In recent years, for reducing the wiring effort, sensors that are incorporated in a wireless manner/via radio, i.e., at least transmit their sensor data via radio are increasingly used.

A problem occurring with heavily vibrating machines, such as presses, is that the electronics is disturbed by the movement or the vibration of the equipment. This has, for example, an influence on the measurement accuracy and/or in particular the wireless transmission. Therefore, there is a need for an improved approach.

### SUMMARY

An embodiment may have a tool machine or tool holder with at least one sensor/actuator unit, the sensor/actuator unit including: a sensor element configured to measure a physical measured quantity acting on the sensor/actuator unit; or sensor element configured to measure a physical measured quantity acting on the sensor/actuator unit in combination with an actuator element; wherein the physical measured quantity, measured by the sensor element, allows conclusions on a movement of the sensor/actuator unit or a force acting on the sensor/actuator unit from the movement; wherein the sensor element includes a force sensor, an acceleration sensor, a pressure sensor, a vibration sensor, an ultrasound sensor, and/or an optical sensor; a radio element configured to transfer a determined sensor value of the sensor element in a wireless manner; a vibrating element including a readjustment, wherein the radio element receives a clock signal from the vibrating element, wherein the readjustment is configured to compensate the clock signal of the vibrating element in dependence on the movement of the sensor/actuator unit.

Another embodiment may have a tool machine or tool holder with a measurement system having an inventive tool machine or a tool holder and at least two sensor/actuator units as well as a radio receiver that is configured to receive data from the at least two sensor/actuator units.

According to another embodiment, a method for operating a sensor/actuator unit in an inventive tool machine or a tool holder may have the steps of: generating a vibration by means of a vibrating element; and compensating a signal of the vibrating element in dependence on the movement of the sensor/actuator unit.

Another embodiment may have a non-transitory digital storage medium having a computer program stored thereon to perform the above method for operating a sensor/actuator unit when said computer program is run by a computer.

Another embodiment may have a machine or tool holder with at least one sensor/actuator unit, the sensor/actuator unit including: a calculating unit configured to calculate a physical quantity acting on the sensor/actuator unit based on a digital model; wherein the physical quantity allows conclusions on a movement of the sensor/actuator unit or a force acting on the sensor/actuator unit from the movement; a radio element configured to transfer a determined sensor value of the sensor element in a wireless manner; a vibrating element including a readjustment, wherein the radio element receives a clock signal from the vibrating element, wherein the readjustment is configured to compensate the clock signal of the vibrating element in dependence on the movement of the sensor/actuator unit.

According to another embodiment, a method for operating a sensor/actuator unit in an inventive tool machine or tool holder may have the step of: determining a physical quantity based on a digital model.

Another embodiment may have a non-transitory digital storage medium having a computer program stored thereon to perform the above method for operating a sensor/actuator unit when said computer program is run by a computer.

Embodiments of the present invention provide a sensor/actuator unit for a tool holder, mechanical equipment, in particular a tool machine or generally for applications with (high) dynamic load, such as impact load. The sensor/actuator unit comprises a sensor element and/or an actuator element as well as a vibrating element. The sensor element is configured to measure a physical measured quantity, such as an acceleration acting on the environment of the sensor/actuator unit or the sensor element. Sensor and actuator elements can also be combined. The vibrating element, such as an oscillator, is provided with readjustment. The readjustment is configured to compensate a signal of the vibrating element in dependence on a movement of the sensor/actuator unit.

According to embodiments, compensating means:
Physical intervention in the sense of readjusting.
Subsequently correcting the (corrupted) signal, e.g., mathematically; or
Considering the “corruption” in the signal during further processing.

According to embodiments, the sensor/actuator unit includes a sensor for determining the movement of the sensor/actuator unit or for determining a quantity describing the movement of the sensor/actuator unit or a force acting on the sensor/actuator unit from the movement. This can be, for example, an acceleration sensor determining the movement. By detecting the movement by means of the sensor, readjustment can take place in dependence thereon. It would also be possible that the sensor and actuator elements are combined, since many actuators, such as piezo actuators, can be simultaneously used as sensors.

Embodiments of the present invention are based on the finding that vibrating elements, such as oscillators in general or piezo crystals or quartz crystals in particular, can be disturbed by an external movement, such as an acceleration or a vibration, which then has an influence on a clock signal to be output. This movement can be determined, wherein then readjustment takes place in dependence on the movement. By combining readjustment and vibrating elements, it is advantageously possible to decouple functions that are frequently implemented in sensor elements, such as radio or also the measurement itself, from external interferences. Additionally, there is the advantage that the sensor element is a significantly more robust with respect to external influences.

According to embodiments, readjustment takes place by means of a control signal, such as a voltage, provided to the vibrating element. In this example, a possible implementation of the vibrating element would be a vibrating quartz, excited, e.g., via a VCO for vibration, and in that way forms a precise oscillator.

In the above embodiments, it has been explained that a control signal is used for readjustment. The control signal or the value of the control signal depends on the movement of the sensor/actuator unit or on a force acting on the sensor/actuator unit. According to a further embodiment, the control signal or the value of the same can be directly proportional in dependence on the movement or a force acting on the sensor actuator unit from the movement. In the above-explained embodiment of a VCO (voltage controlled oscillator), a voltage or a direct voltage is used as control signal, which is then varied in dependence on the movement or a force resulting from the movement.

According to embodiments, the vibrating element outputs a signal, such as a clock signal. According to an embodiment, the sensor/actuator unit includes a radio element. This radio element can use, for example, the vibrating element as clock generator. As explained above, by the compensation, the signal can be corrected, either by active readjustment of the vibrating element or by subsequent mathematical correction of the provided signal. Here, it is advantageous that the radio is not negatively influenced by the movement of the sensor/actuator unit.

According to embodiments, the sensor element includes a temperature sensor, a force sensor, a vibration sensor, or an ultrasound sensor. According to further embodiments, the sensor/actuator unit can include an integrated actuator, integrated piezo actuator or integrated ultrasound actuator.

A further embodiment provides a measurement system for a tool machine including at least two sensor/actuator units as well as a radio receiver configured to receive data from the at least two sensor/actuator units.

A further embodiment provides a tool machine having a measurement system, as explained above, or at least one sensor/actuator unit. The sensor/actuator unit can be integrated in a tool holder, like, e.g., for a forming tool.

A further embodiment provides a method for operating a sensor/actuator unit for a tool machine, wherein the sensor/actuator unit comprises an optional engagement portion configured to establish a connection to a tool of the tool machine, and wherein the sensor/actuator unit comprises a sensor element and/or actuator element, comprising the steps of: generating a vibration by means of a vibrating element; and compensating a signal of the vibrating element in dependence on a movement of the sensor/actuator unit.

Obviously, the method can be computer-implemented.

According to further embodiments, instead of the sensor signal for determining the physical quantity, model-based calculation can be performed. Therefore, further embodiments relate to a tool machine or a tool holder (with a digital twin) comprising a calculating unit configured to calculate a physical quantity acting on the sensor/actuator unit based on a digital model, wherein the physical quantity allows conclusions on the movement of the sensor/actuator unit or a force acting on the sensor/actuator unit from the movement.

### BRIEF DESCRIPTION OF THE DRAWINGS

Embodiments of the present invention will be detailed subsequently referring to the appended drawings, in which:

FIG. 1 is a schematic illustration of a tool machine with a sensor/actuator unit according to a basic embodiment; and

FIG. 2 is a schematic illustration of a sensor/actuator unit according to an extended embodiment.

### DETAILED DESCRIPTION OF THE INVENTION

Before embodiments of the present invention will be discussed in more detail based on the accompanying drawings, it should be noted that equal elements and structures are provided with the same reference numbers such that the description of the same is inter applicable or interexchangeable.

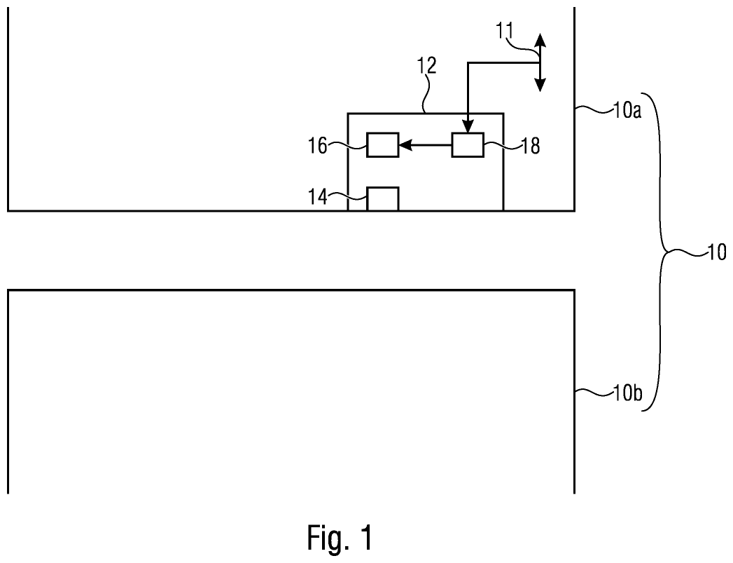

FIG. 1 shows a tool machine 10, here a press having two compression molds 10a and 10b. A sensor unit 12 or a sensor/actuator unit is disposed in the area of the compression molds 10a (tool) with the help of an optional engagement portion (not illustrated). In a sensor configuration, this unit 12 includes a sensor element 14 as well as a vibrating element 16. The tool 10a moves up and down, for example, as illustrated based on the arrow 11.

Obviously, the sensor/actuator unit 12 is also moved by the movement of the tool 10a. Especially with fast or impulsive movements, vibrations of the sensor/actuator unit 12 and its components 14 and 16 result. In particular the vibrating element, such as a piezo crystal of an oscillator, is influenced by the movement or an impulsive movement 11 and in particular by impulsive movements. Here, the electric vibration of the vibrating element may also be influenced. For example, if an oscillator is assumed, the output oscillation signal can have an amended frequency. This frequency interference depends on the movement 11.

Starting from this finding, the vibrating element is to be readjusted by means of a readjustment 18, or generally stated, the signal generated by the vibrating element is to be compensated, e.g., mathematically compensated afterwards. Readjustment generally takes place in dependence on the movement 11. Therefore, the readjustment 18 receives or generates information on the movement 11 and performs readjustment/compensation accordingly.

If it is assumed that the vibrating element is a vibrating quartz of a precise oscillator, the frequency ban be adapted by means of a VCO in that the readjustment 18 outputs a respective control signal or a control voltage. This control signal or the control voltage is selected in dependence on the movement 11. Alternatively, a subsequent correction of the “corrupted” signal or a consideration of the determined “corruption” can take place for the further use of the signal.

With regard to the sensor 14, it should be noted that the same measures a physical measured quantity in the context of the tool machine 10. This can be, for example, a pressure, here a pressure in the area of the press or compression mold 10a. Alternatively, it would also be possible that a temperature sensor, a force sensor, a vibration sensor or an ultrasound sensor is integrated. The vibration sensor or the force sensor could also possibly monitor the movement 11, such that readjustment can take place by means of the readjuster 18. Obviously, according to further embodiments, it is also possible that one or several sensors are provided as sensor technology 14.

As an alternative to the sensor, it would also be possible that an actuator, such as an ultrasound actuator, is used instead of the sensor or in addition to the sensor 14. In particular for a distance sensor on ultrasound basis, typically, an actuator/sensor combination (on piezo basis) is used. The actuator can be placed instead or in addition to the sensor 14.

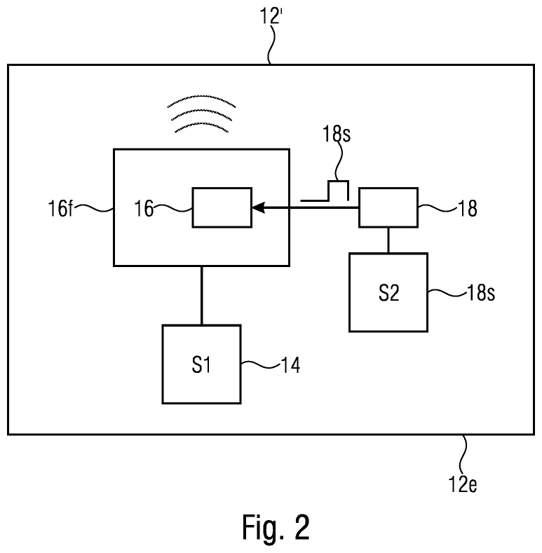

With reference to FIG. 2, an extended variation of the sensor/actuator unit 12, here 12′ will be explained.

As electronic components, the sensor/actuator unit 12′ includes a first sensor 14, a radio transceiver 16f which, in this embodiment, includes or uses the vibrating element 16, as well as the readjustment 18 including an optional sensor 18s. Optionally, a movement sensor 18s is provided as part of the readjustment 18.

Above that, the sensor/actuator unit 12′ includes an engagement portion 12e, here the bottom side of the housing of the sensor/actuator unit 12′.

The transceiver 16f is configured to transmit the sensor values determined by means of the sensor 14 (e.g., temperature sensor) to the outside. For this, a highly accurate oscillator based on a vibrating crystal 16 is used. Here, it should be noted that obviously also the clock signal of the element 16 may be used for a processor or the sensor system 14 or another unit as an alternative or in addition.

This vibrating crystal 16 is readjusted by means of the readjuster 18, wherein a sensor signal of the sensor 18s describing the movement is used as control quantity for the readjustment.

As an alternative to the extra sensor 18s, it would also be possible that the sensor 14 is used as movement sensor or acceleration sensor and the readjustment 18 uses the sensor value (depending on the physical measured quantity) of this sensor 14.

According to an embodiment, instead of the sensor element 14 or 18s described above as separate element, an integrated sensor element, e.g., a sensor element integrated into the vibrating element 16 can be used. With this integrated sensor element 16, the movement 11 can be detected, for example, for readjustment (cf. 18). This self-sensing principle is possible, for example, for piezos as vibrating elements.

Even when it is not illustrated, it should be noted here that obviously also further components such as a battery for current supply or an energy harvester could be provided in the sensor unit 12′.

The underlying method for compensating or specifically for readjusting can be configured as follows: according to embodiments, no readjustment takes place by means of the unit 18 when the sensor 18s detects that no or only an insignificant movement exists. As soon as a movement exists, which can cause an interference, respective readjustment takes place. For this, a control signal is output by the readjuster 18 to the vibrating element 16 or the electronic circuit using the vibrating element 16. This approach represents a hardware readjustment wherein the control signal exerts a direct or indirect influence on the frequency generated by means of the vibrating element 16. An example for direct influence would be the generation of a counter vibration by which, for example, the vibrating element is detuned. A further approach for compensation would be a subsequent correction of the vibrating signal.

Alternatively, the compensation can also be performed mathematically. If a transceiver is assumed as electronic component using the vibrating element 16, the detuned state of the vibrating element 16 can also be considered in the digital generation of the radio signal. In that way, readjustment takes place such that the signal generated by the vibrating element 16 is predistorted.

The readjustment in the above embodiment can be configured, for example, as follows:

For example, the resonant frequency of a VCO is determined by the frequency determining elements, these are, among others, capacitors of this circuit. Typically, a capacitance diode is used. This is an element whose capacitance can be varied by selecting its bias. Thereby, the resonant frequency of the circuit can be adjusted. The same principle of resonant frequency tuning via capacitance diode is also used in a VCXO (voltage controlled crystal oscillator).

A further embodiment relates to a measurement system comprising a sensor unit 12′ transmitting sensor values to a receiver via radio (cf. transceiver 16f). In the above embodiments, the sensor/actuator unit 12 can comprise an engagement portion (screw connection, clamp connection, stand) via which the sensor/actuator unit 12 can be connected to the equipment, e.g., a tool or tool machine.

Even when in the above-stated embodiments a tool machine has been assumed, it should be noted that also further applications are possible in the context of other (mechanical) equipment or generally for applications with (high) dynamic load, such as impact load. Examples are sensor/actuator applications in engines, production equipment, robots, etc.

A further embodiment for a tool machine is a forming machine, such as press where very high impact loads occur. Such machines have a need for sensor technology, such as pressure sensor technology in the area of the forming tool.

According to further embodiments, instead of the direct measurement of the physical quantity, the physical quantity can also be modulated. According to embodiments, this takes place based on a digital twin that simulates the actual state of the machine, such as the tool machine. For this, for example, an input quantity in the form of a control parameter for the movement of the tool machine or also a measured parameter such as by means of an optical measurement can be used. If, for example, a press tool is assumed, it can be modeled which actual movements exist and which accelerations result therefrom, based on the digital twin by using the control parameters of the press. According to further embodiments, this digital model is determined by means of AI.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may be, for example, stored on a machine readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software (computer program).

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A tool machine or tool holder with at least one sensor/actuator unit, the sensor/actuator unit comprising:
a sensor element configured to measure a physical measured quantity acting on the sensor/actuator unit; or sensor element configured to measure a physical measured quantity acting on the sensor/actuator unit in combination with an actuator element; wherein the physical measured quantity, measured by the sensor element, allows conclusions on a movement of the sensor/actuator unit or a force acting on the sensor/actuator unit from the movement;
wherein the sensor element comprises a force sensor, an acceleration sensor, a pressure sensor, a vibration sensor, an ultrasound sensor, and/or an optical sensor;
a radio element configured to transfer a determined sensor value of the sensor element in a wireless manner;
a vibrating element comprising a readjustment, wherein the radio element receives a clock signal from the vibrating element, wherein the readjustment is configured to compensate the clock signal of the vibrating element in dependence on the movement of the sensor/actuator unit.

2. The tool machine or tool holder according to claim 1, wherein the readjustment is configured to readjust the vibrating element during compensation; or
to correct the signal of the vibrating element or to process the same further in a corrected manner during compensation.

3. The tool machine or tool holder according to claim 1, wherein the readjustment is configured to provide a control signal to the vibrating element to readjust the vibrating element.

4. The tool machine or tool holder according to claim 2, wherein the control signal or a value of the control signal depends on the movement of the sensor unit or a force acting on the sensor unit from the movement; or
wherein the control signal or a value of the control signal depends in a direct proportional manner on the movement of the sensor unit or a force acting on the sensor unit from the movement, and/or
wherein the readjustment is configured to provide a voltage or direct voltage as the control signal.

5. The tool machine or tool holder according to claim 1, wherein the vibrating element comprises a piezo crystal or quartz crystal.

6. The tool machine or tool holder according to claim 1, wherein the sensor unit comprises a sensor for determining the movement of the sensor unit or for determining a quantity describing the movement of the sensor unit or a force acting on the sensor unit from the movement.

7. The tool machine or tool holder according to claim 1, wherein the sensor unit comprises an integrated actuator, integrated piezo actuator and/or an integrated ultrasound actuator.

8. The tool machine or tool holder with a measurement system comprising a tool machine or a tool holder according to claim 1 and at least two sensor/actuator units as well as a radio receiver that is configured to receive data from the at least two sensor/actuator units.

9. The tool machine according to claim 1, wherein the tool machine comprises a press machine or a forming machine; and/or
wherein the tool machine comprises a press machine or forming machine and wherein the sensor/or actuator unit is mounted on the forming tool.

10. A method for operating a sensor/actuator unit in a tool machine or a tool holder according to any of the preceding claims, comprising:
generating a vibration by means of a vibrating element; and
compensating a signal of the vibrating element in dependence on the movement of the sensor/actuator unit.

11. The method according to claim 10, wherein compensating comprises readjusting the vibrating element or wherein compensating comprises correcting or corrected further processing.

12. A non-transitory digital storage medium having a computer program stored thereon to perform the method for operating a sensor/actuator unit in a tool machine or a tool holder according to any of the preceding claims, the method comprising:
generating a vibration by means of a vibrating element; and
compensating a signal of the vibrating element in dependence on the movement of the sensor/actuator unit,
when said computer program is run by a computer.

13. A tool machine or tool holder with at least one sensor/actuator unit, the sensor/actuator unit comprising:
a calculating unit configured to calculate a physical quantity acting on the sensor/actuator unit based on a digital model; wherein the physical quantity allows conclusions on a movement of the sensor/actuator unit or a force acting on the sensor/actuator unit from the movement;
a radio element configured to transfer a determined sensor value of the sensor element in a wireless manner;
a vibrating element comprising a readjustment, wherein the radio element receives a clock signal from the vibrating element, wherein the readjustment is configured to compensate the clock signal of the vibrating element in dependence on the movement of the sensor/actuator unit.

14. The tool machine or tool holder according to claim 13, wherein the digital model is based on a digital twin of the tool machine or the tool holder.

15. The tool machine or tool holder according to claim 13, wherein an optical measurement, or a movement parameter, or a control parameter for the tool machine or the tool holder serves as input quantity for the digital model.

16. A method for operating a sensor/actuator unit in a tool machine or tool holder according to claim 13, wherein the method comprises determining a physical quantity based on a digital model.

17. A non-transitory digital storage medium having a computer program stored thereon to perform the method for operating a sensor/actuator unit in a tool machine or tool holder according to claim 13,
wherein the method comprises determining a physical quantity based on a digital model,
when said computer program is run by a computer.
